(19) United States
(12) Patent Application Publication
(10) Pub. No.: US 2026/0115667 A1
(43) Pub. Date: Apr. 30, 2026

(54) Device and Process for Functionalization and Ion Exchange of Polymer Membranes

(71) Applicant: Notark Corporation, The Woodlands, TX (US)

(72) Inventors: Roger Tocchetto, Houston, TX (US); Tukaram Gunale, Bengaluru (IN); Vijay Mhetar, Houston, TX (US)

(73) Assignee: Notark Corporation, The Woodlands, TX (US)

(21) Appl. No.: 19/370,855

(22) Filed: Oct. 28, 2025

Related U.S. Application Data
(60) Provisional application No. 63/712,688, filed on Oct. 28, 2024.

(51) Int. Cl. B01D 61/52; B01D 61/46; B01D 71/30

(52) U.S. Cl. CPC B01D 61/52; B01D 61/461; B01D 71/30

(57) ABSTRACT

A device for treating polymer membranes are disclosed. The device includes a membrane and at least one spacer that defines flow channels along the membrane surface and provides openings for solution contact between adjacent layers. A liquid treatment solution is circulated through the device to enable ion exchange, conditioning, or quaternization of the membrane. In embodiments, the membrane and spacer are wound in a spiral around a tube and arranged inside a housing. A pump circulates the treatment solution through the housing to ensure uniform contact and reaction.

### RELATED APPLICATION

This application claims benefit to U.S. Provisional Application No. 63/712,688, filed on Oct. 28, 2024, which is incorporated herein by reference.

### TECHNICAL FIELD

The present disclosure relates to a device and process for treating polymer membranes, including functionalizing and ion exchange.

### BACKGROUND

Ion exchange membranes are used in a variety of electrochemical systems such as water electrolyzers, fuel cells, redox flow batteries, and electrodialysis units. Such membranes include anion exchange membranes (AEMs), cation exchange membranes (CEMs), and proton exchange membranes (PEMs). Each type contains fixed ionic groups within a polymer matrix and mobile counterions that move through the membrane to complete an electrochemical circuit. For example, AEMs comprise polymers having positively charged groups that conduct anions and repel cations; CEMs comprise polymers having negatively charged groups that conduct cations and repel anions; and PEMs comprise acidic polymers that conduct protons.

In conventional processes for preparing ion-conductive membranes, such as anion exchange membranes (AEMs), halide counterions-typically chloride or bromide often remain in the as-cast or functionalized polymer after polymerization or quaternization. These halides can accelerate corrosion of metallic components in electrochemical devices, interfere with catalytic activity, and reduce long-term membrane stability. Post-quaternization membranes may also contain bromide or tosylate counterions requiring conversion to more stable hydroxide or carbonate forms to achieve the desired performance characteristics. Prior approaches have not been fully successful in achieving uniform and complete removal or replacement of these ions throughout the membrane structure.

There is a need for a device and process that can carry out these membrane-treatment steps in a consistent and scalable manner.

### SUMMARY

The disclosure relates to a method for treating a membrane to swap halide ions of the membrane with hydroxide or carbonate ions. By carrying out the treatment such as ion swap prior to MEA fabrication, corrosive halide salt formation inside the electrochemical stack is avoided, improving durability and reliability. The disclosure also provides device and system designs enabling batch or continuous processing of long membrane rolls at industrial scale.

In one aspect, the device comprises a housing for containing a membrane structure with a spacer between adjacent membrane layers. The spacer allows fluid flow and provides openings for a treatment solution, e.g., a solution of metal hydroxide or carbonate, to be in contact with facing surfaces of the membranes for a time sufficient to replace halide ions with hydroxide or carbonate ions.

In embodiments, the membrane structure includes a spiral configuration and the spacer allows the flow of the solution from a first axial end of the membrane structure and a second axial end of the membrane structure.

In embodiments, providing the membrane structure includes arranging the spacer along a planar surface of the membrane, and winding the membrane with the spacer arranged on the planar surface of the membrane around a tube.

In embodiments, contacting the membrane structure with the solution includes positioning the membrane structure having the spiral configuration inside a housing filled with the solution.

In embodiments, contacting the membrane structure into the solution includes positioning the membrane structure inside a housing with axial ends of the membrane structure arranged facing oppositely arranged end faces of the housing, and pumping the solution through the housing to allow a flow of the solution through the membrane structure in axial direction. In embodiments, the pressure of the solution inside the housing is maintained below a predefined pressure.

According to another aspect of the disclosure, a device for treating polymer membranes is disclosed. The device includes a membrane to be treated and at least one spacer contacting the membrane surface. The spacer is arranged to define a gap or channel allowing a solution to contact the membrane surface, thereby enabling ion exchange or ion conversion. The device includes a housing to contain the membrane, the spacer, and the solution.

In embodiments, the device further comprises a pump fluidly connected to the housing to pump the solution inside the housing. In embodiments, the pump is maintained below a predefined pressure.

According to yet another aspect of the disclosure, a membrane treatment system is disclosed. The membrane treatment system includes a housing containing a membrane structure (membrane and spacer) and a pump that feeds solution through the housing to enable ion exchange between the membrane and solution.

In embodiments, the membrane treatment system further includes a salt scavenger arranged downstream of the device and configured to remove salt from a mixture of solution and salt exiting the housing. In embodiments, the membrane treatment system further includes a filter arranged downstream or upstream of the pump to filter the solution being provided to the device.

In embodiments, the membrane treatment system includes a plurality of devices arranged in a series or parallel configuration.

In some embodiments, the membrane is an anion exchange membrane.

### DESCRIPTION OF DRAWINGS

FIG. 1 illustrates a top perspective view of an assembly having a membrane structure arranged in a spiral configuration around a tube.

FIG. 2 illustrates a side perspective view of the assembly of FIG. 1 depicting the layers of the spacers arranged between the layers of the membrane with a solution moving between the layers of the membrane.

FIG. 3 illustrates an arrangement for forming the membrane structure of FIG. 1 from a spool of a cast membrane and a spool of the spacer.

FIG. 4 depicts a spacer having a mesh structure arranged on a surface of the membrane and depicting a plurality of openings in the mesh structure.

FIG. 5 illustrates an assembly having a membrane structure with layers of tracks of spacers extending along edges of the membrane and between the layers of the membrane.

FIG. 6 illustrates a side view of a portion of the membrane structure of FIG. 5.

FIG. 7 illustrates a sectional view of the assembly depicting the arrangement of the membrane and the two tracks in the membrane structure of FIG. 5.

FIG. 8 illustrates a side perspective of the belt of the membrane structure of FIG. 5.

FIG. 9 illustrates a system to treat a membrane with a solution, e.g., facilitating the treatment of the membrane with the solution.

FIG. 10 illustrates an embodiment of a membrane structure with the membrane and spacer wound around a solid shaft.

FIG. 11 illustrates another embodiment of a membrane structure with the membrane and spacer wound around a perforated tube.

FIG. 12 illustrates a cross-sectional schematic of a membrane structure showing circumferential flow between adjacent membrane layers.

FIG. 13 illustrates an alternative system with the membrane structure arranged in a spooled configuration about multiple rollers.

### DESCRIPTION

The following terms will have the following meanings:

“Anion exchange membrane (AEM)” refers to a polymer membrane or film that either (i) bears reactive sites (e.g., carbon-halogen or carbon-tosyl groups) configured to be converted by quaternization (e.g., with an amine-containing treatment solution) into an anion-conducting membrane comprising covalently bound cationic groups (e.g., quaternary ammonium), or (ii) is itself an anion-conducting polymer membrane or film containing covalently attached positively charged groups that conduct anions and repel cations. The positively charged groups of the AEM electrostatically attract mobile negatively charged ions (counterions) from the surrounding solution, which migrate through the membrane during operation. As used herein, references to “AEM” encompass such precursors where the context concerns their treatment or conversion into the quaternized, anion-conducting form.

“Counterions” refer to the mobile ions present within an ion exchange membrane that balance the fixed ionic charges of the polymer backbone. In an AEM, counterions are anions such as halides (Cl⁻, Br⁻, I⁻, F⁻), hydroxide (OH⁺), carbonate (CO₃²⁻), nitrate (NO₃⁻), sulfate (SO₄²⁻), or organic anions such as acetate, formate, or tosylate. In a CEM or PEM, the counterions are cations such as protons (H⁺, H₃O⁺), alkali or alkaline-earth metals (Li⁺, Na⁺, K⁺, Mg²⁺, Ca²⁺), transition-metal ions, or organic cations including ammonium, tetraalkylammonium, imidazolium, pyrrolidinium, or phosphonium species. The counterions migrate through the membrane, enabling ion transport and exchange during operation.

“Anion exchange membrane electrolyzers (AEME)” or “AEM water electrolyzers (AEMWEs)” are electrochemical cells using an AEM to separate anode and cathode and split water into hydrogen and oxygen.

“Cation exchange membrane (CEM)” refers to a semipermeable polymer membrane containing covalently bound negatively charged groups such as sulfonate (—SO₃⁻), carboxylate (—COO⁻), or phosphonate (—PO₃²⁻) moieties. These fixed anionic groups attract mobile cations, including H⁺, Li⁺, Na⁺, K⁺, NH₄⁺, Mg²⁺, Ca²⁺, or multivalent and organic cations, which migrate through the membrane under an applied potential or concentration gradient.

“Proton exchange membrane (PEM)” refers to a polymer membrane having fixed acidic groups such as sulfonic acid, phosphonic acid, or carboxylic acid moieties that conduct protons (H⁺ or H₃O⁺) as the charge carriers. The PEM functions as a solid electrolyte in electrochemical devices by selectively conducting protons while blocking electron and gas transport.

“Ion exchange membrane (IEM)” refers to any of anion, cation, and proton exchange membranes. An IEM comprises fixed ionic sites and corresponding counterions capable of selective ion transport and replacement. The specific ionic form-such as hydroxide, carbonate, halide, proton, metal cation, or organic ion-depends on the membrane chemistry and the conditioning or ion-exchange treatment applied.

“True Hydroxide Conductivity” test method refers to the method as described by Dekel et al. (Ziv & Dekel, Electrochemistry Communications, 2018) to measure the ionic conductivity of a membrane. In the method, residual carbonate or bicarbonate ions in the membrane are electrochemically purged by applying an external current under controlled conditions, converting those ions back to CO₂ and leaving a fully hydroxide-form membrane. The conductivity measured in that state is considered the true OH⁻ conductivity, reflecting the intrinsic anion transport performance.

“Water Uptake” or “Weight gain” refers to a weight difference (W %) of a membrane before and after immersion in water for a specified period (e.g., 5 hours, 1 day, 1 week, longer, etc.). Weight gain is calculated as: W %=(W2−W1)/W1×100, where W1 is the weight of the membrane before immersion, and W2 is the weight after immersion.

“Ion-Exchange Capacity (IEC)” refers to the total amount of ion-exchangeable sites in a membrane, expressed as milliequivalents per gram (meq/g) of dry polymer. IEC is determined by acid-base titration.

“Ion-Exchange Efficiency” or “Activation” refers to the degree of replacement of initial counterions in a membrane with desired counterions after ion-exchange treatment, expressed as a percentage of the theoretical maximum. The efficiency may be determined by elemental analysis, ion chromatography, or X-ray photoelectron spectroscopy (XPS) based on residual halide or other ions before and after treatment.

“Device” and “System” refer to equipment or assemblies configured to circulate or contain one or more liquid treatment solutions in contact with a membrane. The device or system may be used for ion exchange, conditioning, regeneration, or chemical functionalization of the membrane, including reactions such as quaternization or other ionic substitution or replacement processes. The term “device” may be used interchangeably with “system” or “assembly.” Unless otherwise specified, references to an “ion swap device” or “ion swap system” are intended to refer generally to such devices or systems and are not limited to any particular ion-exchange chemistry or ionic species.

The disclosure here relates to a device, a system, and a method to treat a membrane by contacting the membrane with a liquid treatment solution under controlled conditions. The treatment solution may contain ionic species and/or reactive agents to perform (i) ion exchange, replacement, or conditioning of counterions in anion, cation, or proton exchange membranes; and/or (ii) quaternization of halogenated polymers with amines, optionally followed by rinsing and subsequent ion exchange to place the membrane in a desired ionic form.

The device includes at least one spacer in contact with the membrane to physically support the membrane and to maintain pathways for the solution to flow, for efficient ion exchange. In embodiments, the spacer maintains separation between adjacent membrane layers, ensuring open flow channels for the ion-exchange solution can uniformly contact the membrane surfaces.

Depending on the configuration, the membrane may be folded, stacked as layers, or wound in a spiral around a shaft or tube, with the spacer positioned between the membrane layers. The spacer may be implemented as a mesh sheet, belt-shaped tracks along membrane edges, a sheet with raised bumps, or a compressible material.

In embodiments, the spacer is a compressible spacer that elastically deforms when the membrane swells upon immersion in solution, thereby maintaining contact between the spacer and the membrane while avoiding excessive mechanical stress. The compressible spacer may be formed of polymer foam, elastomeric sheet, non-woven felt, or an expanded mesh that is capable of compressing by 5-70%, or 10-60%, or 15-50% of its original thickness under the swelling forces of the membrane. The compressibility can be provided by inherent elasticity of the material or by a three-dimensional structure such as corrugation, embossing, or voids that allow deformation under pressure. This feature accommodates swelling during either ion-exchange conditioning or chemical functionalization, such as quaternization while preserving uniform contact of the treatment solution with the membrane.

In an embodiment (not shown), the spacer comprises a frame or sheet having a plurality of raised bumps or projections distributed across its surface. The bumps provide point contacts with the membrane, thereby holding adjacent membrane surfaces apart while maintaining open channels for solution flow between the bumps. The bumps may be arranged in a regular grid, staggered array, or random distribution, and may be circular, oval, or polygonal in shape. The bumps may have a height ranging from 0.05 mm to 2 mm, or from 0.1 mm to 1 mm, or from 0.2 mm to 0.5 mm, depending on the membrane thickness and desired channel height. Such a spacer can be formed of polymer, elastomer, or composite sheet material by molding, embossing, or thermoforming, and provides mechanical support with minimal obstruction to solution flow.

In embodiments, the use of a spacer during ion exchange may produce a visible or detectable surface pattern or indentation on the membrane, corresponding to the surface, design, or geometry of the spacer, such as mesh openings, ridges, or raised projections. This surface pattern or indentation can be an indicator that the membrane was processed in contact with a spacer using an ion exchange device described herein.

Anion Exchange Membranes (AEMs) For Swapping Out Counterions: In embodiments, the device is for swapping out counterions in AEMS. In the as-cast state, AEMs typically contain halide counterions such as chloride, bromide, or iodide. For optimized performance, these halides are preferably exchanged for hydroxide (OH⁻) or carbonate (CO₃²⁻) ions, or other anions suitable for the intended electrochemical environment using the disclosed device and method.

In embodiments, AEMs comprise a polymer that is chemically modified to incorporate fixed cationic groups, such as quaternary ammonium, phosphonium, imidazolium, or pyrrolidinium groups, which are responsible for attracting and transporting anions. In embodiments, the base polymer for use in the AEM is selected from the group consisting of poly(ethylene) and polypropylene functionalized with quaternary ammonium groups, polysulfone (PSU), polyphenylene oxide (PPO), poly(arylene ether), polyvinyl alcohol (PVA), poly(ether ether ketone) (PEEK), and styrenic block copolymer (SBC) compositions.

In one embodiment, the AEMs are self-supporting (freestanding) membranes manufactured from functionalized poly(aryl piperidinium) resins. Such polymers incorporate quaternary ammonium groups into the aryl piperidinium backbone to provide fixed cationic sites for anion conduction. These membranes exhibit high chemical stability and mechanical strength, allowing them to be processed in roll form.

In embodiments, the AEMs are from Orion Polymeras CMX or Durion membranes. These membranes are poly(aryl piperidinium)-based anion exchange membranes incorporating tethered quaternary ammonium groups, and are provided as freestanding films.

In embodiments, the AEMs are from Inonomr Innovation Inc. under tradename Aemion+™. These membranes are poly(aryl piperidinium) polymers with quaternary ammonium functional groups, designed to provide high hydroxide conductivity and mechanical robustness.

In embodiments, the AEMs are Sustainion™ membranes from Dioxide Materials. These membranes are based on functionalized poly(arylene ether) backbones carrying quaternary ammonium substituents, and are provided in freestanding film form suitable for use in the device.

In embodiments, the AEMs are based on a functionalized poly(aryl piperidinium) backbone available from Versogen as PiperION membranes, or polynorbornene-based anion exchange membranes from Promerus, LLC.

In embodiments, the AEMs are membranes commercially available under the mark AEMTuff™ from Notark Corporation. These membranes are crosslinked, fluorine-free anion exchange membranes incorporating quaternary ammonium functional groups to provide ion conductivity. They are supplied as free-standing films, ˜40-60 μm thick, with a pentablock copolymer architecture for dimensional stability and durability. AEMTuff membranes exhibit ultra-low swelling and long-term alkaline stability, for example greater than 10,000 hours in 1 M KOH at 80° C., making them suitable for robust handling and ion-exchange processing in the disclosed device.

In embodiments, the AEM membranes comprise a styrene-based multiblock copolymer composition having a selectively quaternized midblock, as disclosed in US Patent Publication No. US20230312849A1, incorporated herein by reference. The selectively quaternized hydrogenated styrenic block copolymer comprises at least a block A derived from (i) para-substituted vinyl aromatic monomers and/or (ii) unsubstituted vinyl aromatic monomers; at least a block B comprising polymerized hydrogenated 1,4-isoprene or 1,2- and 1,4-butadiene units; and a block C as a mid-block or end-block derived from a vinyl aromatic monomer susceptible to quaternization. The selectively quaternized hydrogenated styrenic block copolymer has a general configuration of a pentablock, tetrablock, or triblock containing random B/C or C/B segments, with an ion-exchange capacity (IEC) from 0.5 to 4.0 meq/g; and block C is quaternized to provide quaternary ammonium cations with a degree of quaternization from 30 mol % to 95 mol %.

In embodiments, the AEM comprises a quaternized styrenic block copolymer, as disclosed in US Patent Publication No. US20240209202A1, incorporated herein by reference.

The AEM's conductivity is determined by its ability to transport anions such as hydroxide (OH⁻), carbonate (CO₃²⁻), or other anions depending on the application. In embodiments, the AEM has an ionic conductivity ranging from 1 to 150 milli-siemens per centimeter (mS/cm) at 25° C., depending on the ion-exchange capacity (IEC) and hydration level of the polymer. In embodiments, the conductivity is 1-150 mS/cm, or 2-100 mS/cm, or 5-100 mS/cm at 25° C., measured according to the True Hydroxide Conductivity test method.

In embodiments, the membrane prior to ion-exchange treatment (before replacing halide counterions with hydroxide) has an IEC of about 0.5-3.0 meq/g of dry polymer and, following conversion to the hydroxide form, exhibits the conductivity ranges noted above.

In embodiments, the membrane prior to ion-exchange treatment (before swapping halide or other counterions with hydroxide) has an IEC of 0.5-5.0 meq/g of dry polymer, and following conversion to the hydroxide form exhibits the conductivity ranges noted above. The conductivity is generally correlated with IEC, although the relationship is not strictly linear.

For ion exchange to occur efficiently, the AEM is characterized as having a sufficient degree of hydration to maintain high ionic conductivity. In embodiments, the membrane has a water-uptake value ranging from 1 to 100% by weight, based on total weight of the membrane, or greater than 2%, or less than 40%, measured after 4 weeks at 25° C. Together with IEC, the degree of hydration governs the observed conductivity: higher IEC supports higher conductivity, but adequate hydration is required to realize the membrane's ion-transport potential.

In embodiments, prior to ion exchange, the AEM is characterized as having a halide (e.g., Br⁻) content of 1-20 wt %, or 5-18 wt %, or 10-15 wt %, based on the total weight of the polymer membrane, as determined by ion chromatography or elemental analysis. This initial halide content represents counterions that are replaced with hydroxide, carbonate, or other target ions during ion exchange.

Cation Exchange Membranes (CEMs): In embodiments, the device is for treating cation exchange membranes (CEMs) by contacting the membrane with an electrolyte solution containing the desired exchange ions under controlled conditions. CEMs contain fixed anionic groups, such as sulfonate (—SO₃⁻), carboxylate (—COO⁻), or phosphonate (—PO₃²⁻) moieties, which are electrically balanced by mobile cations within the polymer matrix. During ion exchange, these mobile cations are replaced by other cations supplied by the contacting electrolyte solution.

In embodiments, the CEM initially containing sodium (Na⁺) or potassium (K⁺) as the charge-compensating ions, and get converted to a lithium (Li⁺), magnesium (Mg²⁺), or calcium (Ca²⁺) form by immersing or circulating through the device a solution of the corresponding metal salt, such as a nitrate, chloride, or sulfate. Conversely, a membrane in a multivalent cation form can be reconditioned to a monovalent form (e.g., Na⁺ or H⁺) by contacting it with a solution containing the desired exchange cation. The process proceeds by ion diffusion and charge balance between the membrane and the solution until the original cations are replaced by the ions from the electrolyte. Completion of exchange can be verified by weight stabilization, ion chromatography, or elemental analysis of the residual cations.

In embodiments, the CEMs comprise polymers bearing sulfonic acid, carboxylic acid, or phosphonic acid groups, such as perfluorosulfonic acid (PFSA) polymers, posulfonated poly(ether ether ketone) (SPEEK), sulfonated polysulfone, sulfonated polyimide, polybenzimidazole, or aromatic copolymers containing fluorinated or hydrocarbon segments. CEMs may be supplied as freestanding films or reinforced membranes and are suitable for treatment in the device either in roll form or as discrete sheets.

Prior to ion exchange, CEMs typically contain metal cations such as Na⁺, K⁺, Ca²⁺, or Mg²⁺ at a level of about 1-15 wt %, or 3-10 wt %, based on the total weight of the dry membrane, as determined by ion chromatography or elemental analysis. Following ion exchange or reconditioning, the residual concentration of the original cations is reduced by at least 80%, or to less than 1000 ppm, depending on treatment conditions.

In embodiments after ion exchange or reconditioning, the CEM exhibits an ion-exchange capacity (IEC) ranging from 0.5 to 5 meq/g, or 0.8 to 4.0 meq/g of dry polymer, and an ionic conductivity of 1 to 150 mS/cm, or 5 to 80 mS/cm, measured at 25° C. using a standard two-probe conductivity method. The degree of hydration may range from 5 to 40 wt % after equilibration in deionized water at 25° C., depending on the polymer backbone and counterion type.

Proton Exchange Membranes (PEMs): In embodiments, the device is configured for treating proton exchange membranes (PEMs) that contain fixed sulfonic acid or similar acidic groups charge-balanced by protons (H⁺). In the treatment process, these protons can be exchanged for metal cations present in the surrounding electrolyte. For example, a PEM in the proton form may be converted to a lithium (Li⁺), sodium (Na⁺), potassium (K⁺), magnesium (Mg²⁺), or calcium (Ca²⁺) form by immersing the membrane in or circulating through the device a solution of the corresponding metal salt, such as lithium nitrate, sodium chloride, or potassium sulfate. Conversely, a PEM that has been converted to a metal-ion form can be re-protonated using an acid solution such as hydrochloric acid, sulfuric acid, nitric acid, or phosphoric acid.

The conversion may be carried out in one or more stages, for instance H⁺→Na⁺→Li⁺ or the reverse, to moderate swelling and control ion mobility. The extent of proton or metal-ion replacement can be monitored by conductivity measurement, titration of released ions, or weight stabilization.

In embodiments, PEMs comprise polymers bearing sulfonic acid or related acidic groups, including perfluorosulfonic acid polymers such as Nafion™, Aquivion™, or Flemion™, as well as hydrocarbon-based alternatives such as sulfonated poly(ether ether ketone) (SPEEK), sulfonated polysulfone, or polybenzimidazole (PBI) doped with acid species. These membranes may be processed in the same mechanical configuration as the AEM and CEM membranes, allowing uniform solution exposure and ion exchange within the same device housing.

Prior to ion exchange, PEMs are typically in the proton (H⁺ or H₃O⁺) form or contain residual metal ions such as Na⁺, K⁺, or Ca²⁺ from manufacturing or prior operation. The total cation content may range from 0.5 to 10 wt % based on the dry membrane, or from 0.01 to 1 meq/g in ion-exchange equivalents. Following treatment in the device, the target ionic form—proton, lithium, sodium, or other—is obtained with a residual foreign-ion content below 1000 ppm or reduced by at least 90%. In embodiments, the PEM exhibits an IEC of 0.5 to 5 meq/g of dry polymer and an ionic conductivity ranging from 10 to 150 mS/cm, or 20 to 100 mS/cm, at 25° C. Water uptake typically ranges from 5 to 35 wt % depending on the counterion species and polymer composition.

Quaternization of Halogenated Polymers: In embodiments, the device is configured to carry out in-situ quaternization treatment of polymer membranes or films containing covalently bound halogen atoms, such as bromine or chlorine (AEM precursor as previously defined). During this treatment, a liquid solution containing one or more amine compounds is circulated through or maintained in contact with the membrane under controlled temperature and residence conditions. The amine compounds interact with the covalently bound halogen sites to form quaternary ammonium groups, thereby converting the precursor polymer into a cationic, anion-conducting membrane. The quaternization may be performed in batch mode, with the membrane immersed in the amine solution, or in continuous mode, with the amine solution circulated through the device housing.

In embodiments, the amine compound is selected from primary, secondary, tertiary, or cyclic amines, including but not limited to trimethylamine (TMA), triethylamine (TEA), N,N-dimethylethylamine (DMEA), N,N-dimethylbutylamine (DMBA), N-methylpiperidine, N-methylmorpholine, 1,4-diazabicyclo[2.2.2]octane (DABCO), imidazole, N-methylimidazole, or mixtures thereof. In other embodiments, diamines or multifunctional amines may be employed to introduce crosslinking or multi-site quaternized structures. Representative diamines include ethylenediamine, 1,6-hexamethylenediamine, N,N,N′,N′-tetramethyl-1,3-propanediamine, piperazine, homopiperazine, m-phenylenediamine, 4,4′-oxydianiline, diethylenetriamine, or tetraethylenepentamine. The treatment solution may contain the amine in water, alcohol, or a mixed aqueous-organic solvent at a concentration from 0.1 to 5 M and may optionally include a base scavenger or phase-transfer agent.

During quaternization treatment, halogen-substituted sites within the polymer are progressively converted to quaternary ammonium groups, while soluble halide species are released into the treatment solution. The solution temperature ranges from 10° C. to 80° C., or 25° C. to 60° C., depending on membrane stability and target conversion level. Upon completion of treatment, the amine solution is withdrawn and the membrane is rinsed with deionized water or alcohol to remove any remaining soluble materials. A subsequent ion-exchange conditioning step may then be carried out in the same device to replace halide counterions (e.g., Br or Cl⁻) generated during quaternization with hydroxide (OH⁻), carbonate (CO₃²⁻), or other desired anions.

The degree of quaternization (DQ) of the treated membrane ranges from 20 mol % to 95 mol %, or 40 mol % to 90 mol %, as determined by elemental analysis or NMR spectroscopy. Following quaternization and subsequent ion exchange, the membrane typically exhibits an ion-exchange capacity (IEC) of 0.5-5.0 meq g⁻¹ of dry polymer and an ionic conductivity of 1-150 mS cm⁻¹ measured at 25° C. Dimensional change under hydrated conditions may be less than 15%, depending on the polymer backbone and crosslinking density. The quaternized membrane can serve directly as an anion-exchange membrane or as an intermediate for further chemical or ionic conditioning. In embodiments, use of the device for quaternization provides uniform conversion across the membrane surface, corresponding to a degree of quaternization within the ranges noted above and consistent with substantially complete utilization of the reactive halogen or tosyl sites.

In embodiments, the device is configured for treating polymer membranes that have been previously functionalized, for example by bromination or tosylation, to introduce reactive leaving groups. The device is used to perform quaternization treatment of such membranes by circulating an amine-containing solution through or in contact with the membrane under controlled conditions. The treatment converts the reactive halide or tosylate groups to quaternary ammonium sites and simultaneously removes residual ionic species generated during the conversion. Subsequent rinsing or ion-exchange conditioning may be performed in the same device to replace any remaining halide or tosylate counterions with hydroxide, carbonate, or other desired anions.

Post-Treatment and Membrane Conditioning. Following conversion of brominated or tosylated precursors to the quaternary ammonium form, the membrane may be further conditioned using the device to remove or replace residual ionic species generated during treatment. In embodiments, the liquid treatment solution contains hydroxide, carbonate, or other anions suitable for replacing halide or tosylate counterions, thereby producing a membrane in its operational ionic form. The same device may also be used for intermediate rinsing, neutralization, or solution replacement between treatments to ensure uniform properties across the membrane area. The treated membrane is then ready for handling, drying, or subsequent assembly.

Sequential Functionalization Pathways for AEM and PEM Formation. In embodiments, the device and process may be used to perform stepwise membrane functionalization treatments to prepare anion exchange membranes (AEMs) or proton exchange membranes (PEMs) from hydrogenated polymer precursors.

For AEM formation, the process typically includes two stages: (i) a first functionalization step, such as bromination or tosylation of the polymer to introduce reactive or activated sites, followed by (ii) a second functionalization step, such as quaternization using an amine-containing treatment solution, to introduce quaternary ammonium groups as the cationic sites of the membrane. When a brominated or tosylated intermediate is used, a subsequent ion-exchange step may also be conducted in the same device, or in series with a second device, to replace halide counterions with hydroxide, carbonate, or other desired anions.

For PEM formation, a single functionalization treatment such as sulfonation or introduction of other acidic groups is sufficient to form the proton-conducting structure, followed by ion conditioning using the device. The ability to conduct these operations in sequence, by exchanging or circulating different treatment solutions through the same hardware, enables efficient and reproducible membrane preparation using a common device platform.

Membrane Form and Handling Characteristics. Following treatment in the device, the membranes are characterized as freestanding films having sufficient mechanical integrity for use in unwinding, coating, winding, slitting, and other web-handling operations. In embodiments, the membranes may be processed in roll form or as stacked sheets within the device, regardless of type (anion, cation, or proton exchange) or treatment (ion exchange, conditioning, or quaternization).

In embodiment, the membrane thickness ranges from 1 to 150 μm, or 5-100 μm, or 10-80 μm, or 20-50 μm. In embodiments, the membrane length is from 5 to 1000 m, or 20-500 m, or 50-250 m, with a width of 10-100 cm, or 25-50 cm, or 30-40 cm. These dimensions and mechanical properties enable the membranes to be handled in continuous or batch configurations during any of the treatment operations described above.

Treatment Method(s): The device and method described herein are suitable for treating polymer membranes of various types—including anion, cation, and proton exchange membranes, as well as halogenated or hydroxyl-functional membranes—by contacting the membrane with a liquid treatment solution for a controlled duration. The treatment involves circulating or maintaining a solution containing ionic or functionalizing agents in contact with one or more membrane surfaces until the desired ionic exchange, conditioning, or chemical modification is achieved. The extent of treatment is governed by parameters such as residence time, solution concentration, temperature, and membrane configuration within the housing.

In embodiments, the treatment may be conducted in batch mode by immersing the membrane or membrane structure in the solution for a selected contact period, or in continuous mode by circulating the solution through the housing using a pump. The contact or residence time is selected from 10 minutes to 48 hours in batch operation, or from 0.1 to 6 hours in continuous operation, depending on the membrane type and treatment chemistry. The treatment solutions used in the device may contain ionic or functionalizing species suitable for the particular operation being performed, e.g., hydroxide, carbonate, or other anions as previously defined, and suitable amine-containing solutions for quaternization treatment. The specific concentration, solvent composition, and contact time are selected according to the membrane chemistry and desired level of conversion

In embodiments, the treatment solution concentration ranges from 0.01 to 7 M, or 0.1 to 5 M, and the temperature ranges from 10° C. to 80° C., or 20° C. to 60° C. The pump or flow system provides circulation sufficient to maintain uniform exposure of the membrane surfaces without mechanical distortion or compression of the spacer layers.

Representative operations include, but are not limited to: (a) ion exchange or conditioning, in which counterions originally present in the membrane (e.g., halides, protons, or metal cations) are replaced with other ions such as hydroxide, carbonate, sulfate, nitrate, or desired cations (Li⁺, Na⁺, K⁺, Ca²⁺, etc.); and (b) quaternization treatment, in which halogen-substituted polymers are contacted with amine-containing solutions to introduce quaternary ammonium sites. Each of these treatments is carried out within the same device architecture, allowing sequential or single-stage processing of membranes using interchangeable solutions

In continuous or semi-continuous operation, the residence time of the membrane in contact with the treatment solution is determined by the membrane feed rate, the volume of the housing, and the flow path length through the spacer or roller assembly. In roller-based configurations where the membrane advances through a static bath, the residence time is determined by the immersion length and feed speed, corresponding to the ranges described above. The process can therefore be tuned to achieve uniform conversion or ion exchange across the full membrane surface area.

In embodiments, the contact time between the membrane and treatment solution is controlled to achieve the desired level of ionic exchange or functionalization. In batch operation, the membrane may be immersed in the treatment solution for 6-48 hours, or 12-36 hours, or 18-24 hours at a temperature of 20-60° C. In continuous operation, the solution is circulated through the housing for an effective residence time of 1-6 hours, or 1.5-4 hours, at comparable temperatures. The circulation rate ranges from 0.01 to 10 L min⁻¹, or 0.05 to 5 L min⁻¹, depending on housing volume and membrane surface area, sufficient to maintain uniform contact without mechanically distorting the membrane.

In embodiments such as a roller-based configuration where the solution is maintained as a static bath and the membrane is advanced across a series of rollers through the bath, the effective residence time of the membrane in the solution is controlled by the membrane feed speed and path length through the housing. In this case, the residence time corresponds to the same residence time ranges described for continuous circulation mode (e.g., 1-6 hours, 1.5-4 hours, 2-3 hours).

Following treatment, the membrane may be rinsed with deionized water, alcohol, or other compatible solvent to remove residual soluble materials. If desired, a subsequent treatment step—such as ion exchange following quaternization, or amination following tosylation—can be performed in the same device without removal of the membrane. In embodiments, the treated membrane exhibits a reduction in residual undesired ions (e.g., halides or extraneous metals) of at least 80%, or to less than 1000 ppm, as determined by ion chromatography, elemental analysis, or X-ray photoelectron spectroscopy (XPS).

After treatment, the membrane exhibits ionic and mechanical properties corresponding to its conditioned ionic form. In embodiments, the ion-exchange capacity (IEC) of the treated membrane ranges from 0.5 to 5.0 meq g⁻¹ of dry polymer, depending on membrane type and functionalization chemistry. After ion exchange or quaternization, the membrane typically shows an ionic conductivity of 1 to 150 mS cm⁻¹ at 25° C. and a dimensional change upon hydration of less than 15%. The water-uptake value generally ranges from 1% to 100% by weight, depending on the ionic form and polymer composition.

In embodiments, use of the disclosed device and system provides a high degree of ionic replacement within the treated membrane. The ion-exchange efficiency, expressed as the percentage of original counterions replaced by the desired ions, may reach at least 80%, or 90%, or 95%, corresponding to substantially complete activation of the membrane. Such high efficiency reflects the uniform flow distribution and controlled residence time achieved within the device, minimizing regions of incomplete exchange and ensuring reproducible conditioning across large membrane areas.

The treatment methods described above may be implemented using the device configurations illustrated in the figures. The device facilitates uniform solution contact with both membrane surfaces through the use of spacers and defined flow or diffusion pathways, enabling consistent ion exchange or functionalization across the membrane area

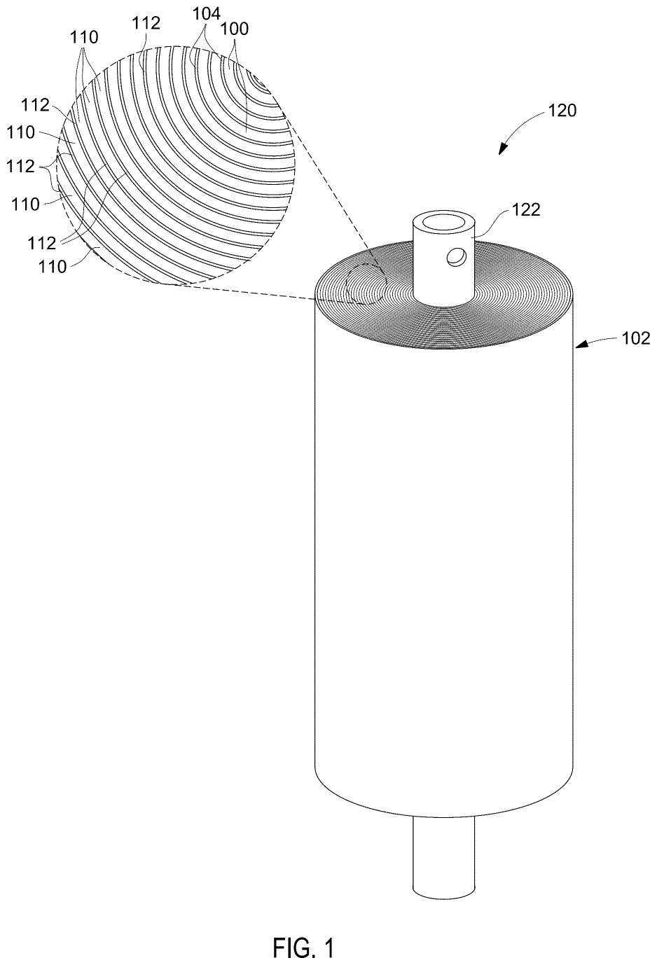

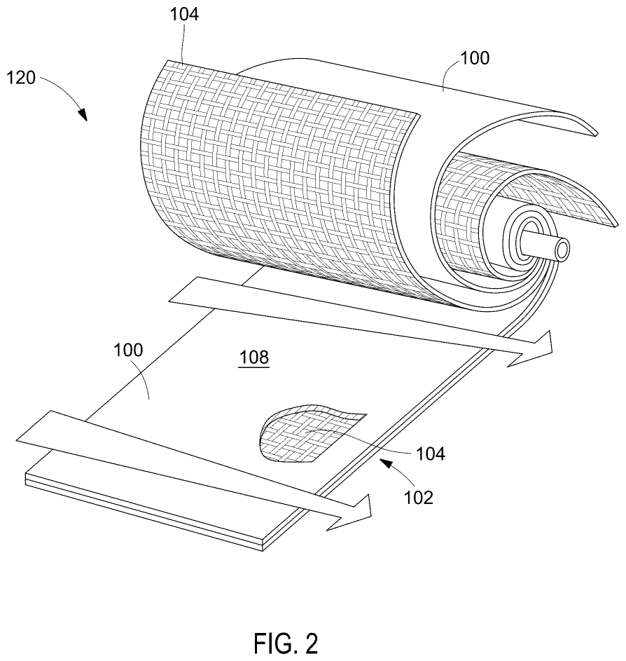

Referring to FIGS. 1-2, in some embodiments, to facilitate the swapping of halide ions of the membrane 100 with the ions of the solution (represented by the arrows in FIG. 2), the method includes providing a membrane structure 102, shown in FIGS. 1 and 2, having the membrane 100 and at least one spacer, for example, a single spacer 104, arranged contacting a surface 108 of the membrane 100. In the embodiment shown in FIG. 1, the membrane structure 102 includes the membrane 100 and the spacer 104 arranged in a spiral configuration such that the membrane 100 is arranged into a plurality of circular membrane layers 110 (e.g., layers formed by the spiral winding), with the spacer 104 arranged into a plurality of spacer layers 112 such that a single spacer fold 112 is arranged between two adjacently arranged membrane layers 110.

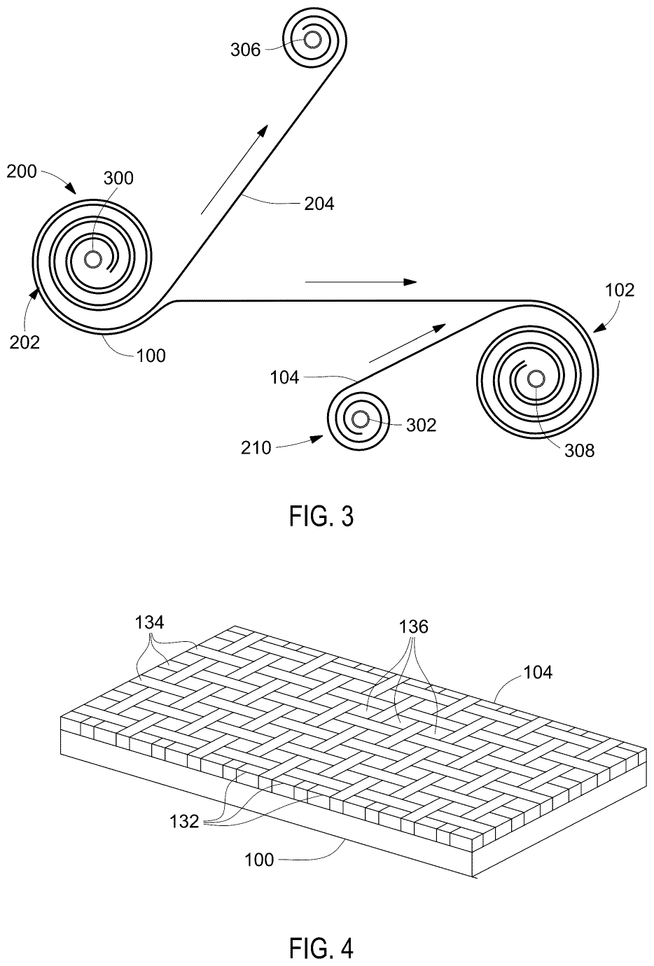

In embodiments, the membrane structure is formed by using a cast membrane having the membrane arranged or coated on a substrate. Accordingly, the substrate is removed from the membrane, and then the membrane is placed adjacent to the spacer, contacting a surface of the membrane, before winding the membrane and the spacer together to form a spool. An example method of forming the membrane structure 102 is illustrated in FIG. 3. Referring to FIG. 3, a spool 200 of a cast membrane 202 is attached to a suitable first roller 300 to enable an unwinding of the cast membrane 202 from the spool 200. As shown, the cast membrane 202 includes the membrane 100 arranged or attached or coated on a surface of a substrate 204. The substrate 204 may be a PET (polyethylene terephthalate) substrate. Also, a spool 210 of the spacer 104 is attached to a second roller 302 to unwind the spacer 104 from the spool 210.

In embodiments, for forming an assembly 120, shown in FIGS. 1 and 2, having the membrane structure 102, the substrate 204 is separated from the membrane 100 by peeling and removing the substrate 204 from cast membrane 202. The peeled substrate 204 is engaged to a tube or shaft attached to a third roller 306 for winding the substrate 204 on the tube or shaft.

Further, the technician arranges a free end of the spacer 104 abutting to a free end of the membrane 100 peeled from the cast membrane 202. Thereafter, the membrane structure 102, and hence the assembly 120, is formed by winding the membrane 100 and the spacer 104 together on a tube 122, shown in FIGS. 1 and 2, attached to a fourth roller 308. In embodiments, for winding the substrate 204 in a spiral configuration, and for winding the membrane structure 102 around the tube 122 in the spiral configuration, the third roller 306 and the fourth roller 308 may act as drive rollers, while the first and second rollers 300, 302 may be the driven rollers. Accordingly, the membrane structure 102 is wound around the tube 122, and the peeled substrate 204 is wound around the shaft, while the membrane 100, the substrate 204, and the spacer 104 is unwound from respective spools 200, 210 in response to the rotation of the third and fourth rollers 306, 308. It may be appreciated that as the membrane 100 and the spacer 104 abutted to the surface of the membrane 100 are wound around the tube 122, the spacer 104 and the membrane 102 are arranged such that a single circular spacer fold 112 is disposed between each of the two adjacently or consecutively arranged membrane layers 110. Water may be sprayed on the membrane 100 to facilitate engagement of the membrane 100 with the spacer 104. In the embodiment, the spacer 104 may be a sheet of woven or non-woven fabric, with a width substantially equal to that of the membrane 100.

In some embodiments, the cast membrane 202 may include two substrates arranged such that the membrane 100 is sandwiched between the two substrates. In such a case, both the substrates are peeled or removed from the surfaces of the membrane 100 before abutting the membrane 100 with the spacer 104. In such a case, two third rollers 306 may be used. In some embodiments, the membrane 100 without the substrate 204 may be utilized for forming the membrane structure 102. In such a case, a spool of membrane 100 is mounted on the first roller 300 to form the membrane structure 102, and the third roller 306 is omitted.

In FIG. 4, the spacer 104 includes a mesh structure having a plurality of strands 132 extending in a first direction, for example, a longitudinal direction, and a plurality of second strands 134 extending in a second direction, for example, a lateral direction, and crossing the plurality of first strands 132 and defining at least one opening, for example, a plurality of openings 136, therebetween. Due to the openings 136 of the spacer 104, the solution, flowing or present or disposed between the two adjacent membrane layers 110, contacts the facing surfaces of the membrane layers 110, facilitating the ion exchange between both the membrane layers 110 of and the solution.

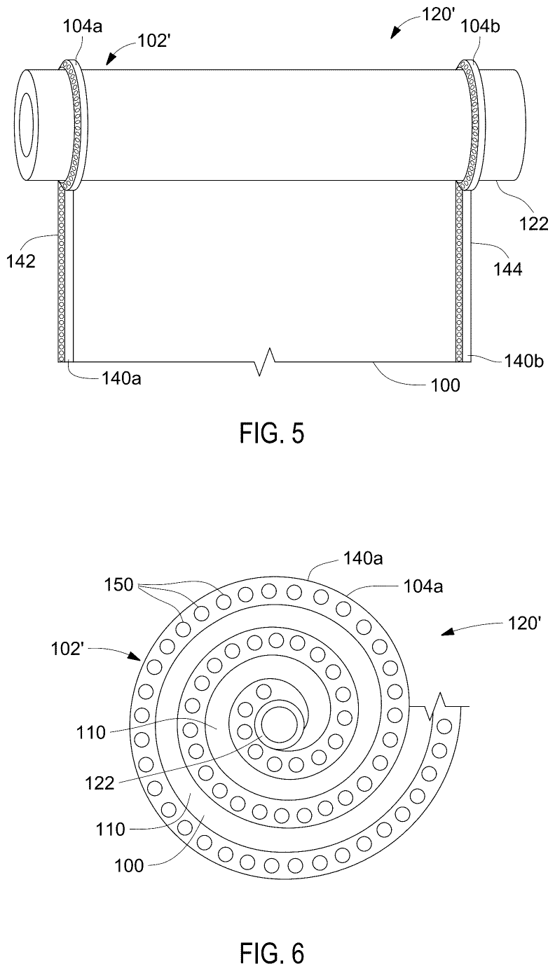

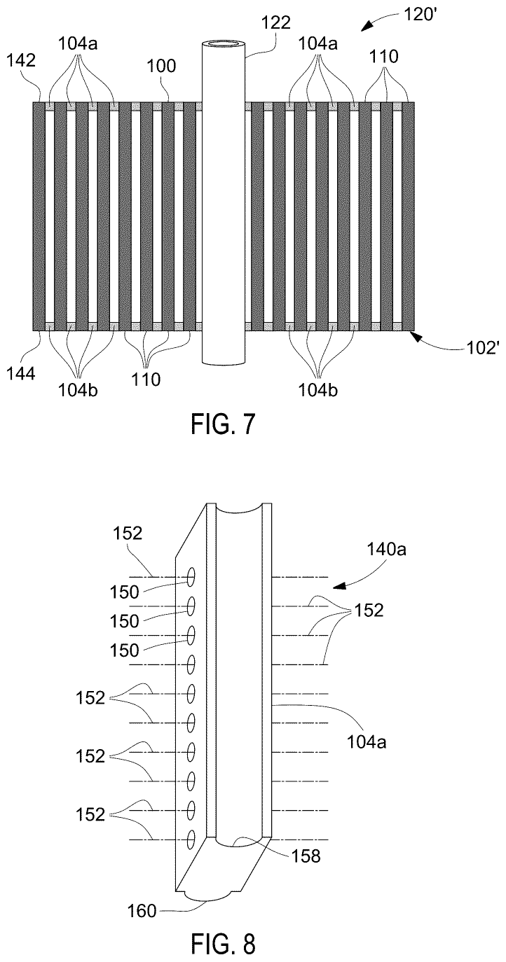

Referring to FIGS. 5, 6, and 7, an alternative membrane structure 102′ is shown. As shown, the membrane structure 102′ includes the membrane 100 and two spacers 104a, 104b in the form of belts or tracks 140a, 140b arranged along the two longitudinal edges 142, 144 of the membrane 100, with the membrane structure 102′ disposed in a spiral configuration around the tube 122 forming an assembly 120′. Referring to FIG. 6 and FIG. 8, the belt 140a includes a substantially cuboidal shape with a plurality of the through holes 150 arrayed along a length of the belt 140a, and each hole 150 extending along a width of the belt 140a. In the assembly of the belt 140a with the membrane 100, central axes 152, shown in FIG. 8, of the holes 150 extend along the axial direction of the tube 122. The solution moves between the adjacently arranged membrane layers 110 via the holes 150 of one of the belts 140a, 140b, and contacts the facing surfaces of the consecutively arranged membrane layers 110, and exit the membrane layers 110 through holes 150 of other of the belts 140a, 140b.

In embodiments as shown in FIG. 8, an upper surface of the belt 140a includes a groove 158 extending along the entire length of the belt 140a, and a lower surface of the belt 140a includes a projection 160 extending along an entire length of the belt 140a. It may be noted that in the membrane structure 102′, the projection 160 associated with one fold of the belts 140a, 140b is arranged inside the groove 158 of the adjacently arranged fold of the belts 140a, 140b with the membrane 100 arranged between the projection 160 and the groove 158, securing membrane layers 110 between the layers of the belts 140a, 140b. This “track” configuration leaves an open channel between the membrane layers, allowing the membrane to swell freely without being constrained by a liner and ensuring electrolyte access to both sides of the membrane during treatment. Accordingly, the projection 160 and the groove 158 facilitate the correct alignment of the adjacently arranged layers of the belts 140a, 140b.

The membrane structure 102′ is formed similarly to the formation of the membrane structure 102 except that instead of a single spacer spool 210, two spools of belts 140a, 140b are mounted on two separate rollers and the belts 140a, 140b are arranged along the longitudinal edges 142, 144 of the membrane 100 peeled from the cast membrane 202, and then wound in the spiral configuration.

In embodiments, the membrane structure 102′ includes a plurality of reinforcing rods extending between the membrane layers 110 and extending substantially perpendicularly to the belts 140a, 140b and connected with the belts 140a, 140b to provide additional strength to the membrane structure 102′, and prevent buckling or distortion of the membrane layers 110.

Although the membrane structure 102, 102′ is shown to be arranged in spiral configuration, it may be appreciated that the membrane structure 102. 102′ may be arranged in a sheet form having layers of the membrane 100 arranged as long plane sheet on top of each other with the spacer 104 or belts 140a, 140b arranged between adjacent layers. In some embodiments, the membrane structure 102, 102′ includes a plurality of separate membranes 100 arranged in sheet form on top each other with a plurality of spacers 104 or belts 140, 140b arranged between the plurality of membranes 100. Although the planar or spiral configuration of the membrane structure are contemplated, it may be appreciated that the membrane structure may be arranged in any other suitable shape or configuration such that a spacer or belt is arranged between adjacent layers or layers of the membrane 100.

It may be noted that the membrane 100 swells when contacted with the solution, and accordingly, the spacer 104, 104a, 104b are compressible spacer adapted to be compressed to allow the swelling of the membrane 100 to prevent any distortion of the shape of the membrane structure 102, 102′, while allowing the solution to flow through the space or openings defined between adjacently arranged layers of the membrane structure 102, 102′.

Upon forming the membrane structure 102, 102′, the method includes soaking or contacting the membrane structure 102, 102′ inside the solution. For so doing, the membrane structure 102, 102′ i.e., the assembly 120, 120′ is arranged inside a suitable housing and solution is fed or pumped through the housing at a predefined rate. In embodiments, the solution is circulated at relatively low pressure (e.g., <2 bar). In some embodiments, instead of pumping the solution through the housing, the solution is stored inside the housing and the membrane structure 102, 102′ is immersed inside the solution and kept inside the solution for a predetermined duration to enable an exchange of halide ions with the hydroxyl or carbonate ions.

In some embodiments, after ion exchange, the membrane structure is rinsed with deionized water to remove residual salt and then dried, for example with air or nitrogen, prior to further handling or assembly. This optional rinse/dry step reduces carryover of salts into downstream processes

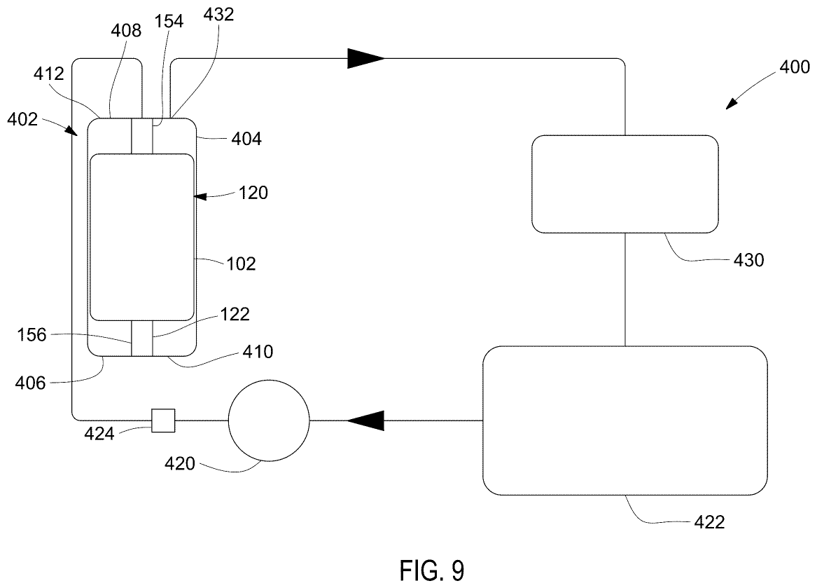

Referring to FIG. 9, a system 400 is shown that facilitates the soaking of the membrane structure 102 inside the solution. The system 400 includes a device 402 having a housing 404 having a first end face 406 and a second end face 408 arranged opposite to the first end face 406. In the illustrated embodiment, the housing 404 is hollow cylindrical housing 408 and the first end face 406 is a base 410 of the housing 404, while the second end face 408 is a removable lid 412 of the housing 404. However, it may be appreciated that the housing 404 may include any other shape, such as, cube, cuboidal, or any other suitable shape known in the art.

As shown in the FIG. 9, the assembly 120 of the device 402 is arranged inside the housing 404. In the assembly, an axial end, for example, a first axial end 154, of the tube 122, is connected to the lid 412 of the housing 404, while another axial end, i.e., a second axial end 156 of the tube 122 is arranged proximate to or contacting the base 410 of the housing. Also, the tube 122 includes an inlet opening defined proximate to the first axial end 154 and an outlet opening arranged proximate to the second axial end 156 of the tube 122. A conduit extends from a pump 420 to the inlet opening of the tube 122 to provide solution of the device 402. In some embodiments, the inlet opening of the tube 122 may extend outside the housing 404. Alternatively, the inlet opening of the tube 122 is arranged inside the housing 404, and the conduit may extend inside the housing 404 and connected to the tube 122. Accordingly, in the shown arrangement of the device 402, the solution enters conduit 122 through the inlet opening of the tube 122, flows through the tube 122, exits the tube 122 through the outlet opening arranged proximate to the base 410 of the housing 404 and enters the housing 404, then and moves upwardly towards the lid 412 and through the membrane structure 102.

To store the solution, the system 400 includes a tank 422, and the pump 420 pumps or feeds the solution to the device 402 i.e., tube 122. In some embodiments, the system 400 may also include a filter 424 arranged downstream of the pump 420 and between the pump 420 and the device 402 to filter any foreign particulate matter from the solution before feeding the solution inside the housing 404 and through the membrane structure 102 to prevent any damage to the membrane structure 102 or clogging of the space defined between consecutively arranged layers 110 of the membrane. Although the filter 424 is arranged to be shown downstream of the pump 420, it may be envisioned that the filter 424 may be arranged upstream of the pump 420 and between the pump 420 and the tank 422.

Also, the system 400 may include a salt scavenger or filter 430 arranged downstream of the device 402 and fluidly connected to an outlet 432 of the housing 404 to receive a mixture of solution and salt exiting the housing 404. As shown, the outlet 432 is defined at a top of the housing 404 i.e. the lid 412 defines the outlet 432 of the device 402. It may be noted that salt is formed due to the chemical reaction that takes place between the polymer of the membrane 100 and solution to enable swap of the halide ions of the membrane 100 with the hydroxyl or carbonate ions of the solution. The salt scavenger 430 is arranged to remove the salt from the solution and provide the filtered solution back to the tank 422. In some embodiments, the salt scavenger 430 may be omitted.

A flow path of the solution inside the device 402 is now described. The solution enters the device 402 from the pump 420 through the inlet opening of the tube 122 which is arranged proximate to the lid 412 of the housing 404, flows through the tube 122 and exit the tube 122 through the outlet opening of the tube 122 arranged proximate to the base 410 of the housing 404. Upon exiting the tube 122, the solution starts filling the housing 404 and moves upwardly towards the lid 412 and exit the housing 404 i.e., the device 402 through the outlet 432. As the solution flows upwardly i.e., along the axial direction of the membrane structure 102 i.e., tube 122, the solution passes between the layers 110 of the membrane 100 due to the presence of the openings 136 or the gap defined between the layers 110 of the membrane 100, contacting the facing surfaces of the layers 110 of the membrane 100.

In some embodiments in which the membrane structure 102′ is used, the solution enters between the layers 110 of the membrane 100 through the holes 150 of one of the belts 140a, 140b and exit the membrane structure 102′ through the holes 150 another of the belts 140a, 140b.

Although the solution is shown to enter the tube 122 from top of the housing 404 and exit the housing 404 from the top of the housing 404 as shown and contemplated, it may be envisioned that the solution may enter the tube 122 or housing 404 from one end face and exiting from any other face, for example, opposite end face of the housing 404 is also possible and scope of the disclosure is not limited by locations of entry and exit of the solution from the housing 404.

As the solution flows through the membrane layers 110, contacting the membrane surface, a chemical reaction takes places between the polymer of the membrane 100 and the solution, causing the swap of halide ions of the membrane 100 with the hydroxyl or carbonate ions of the solution. It may be appreciated that as the solution is pumped inside the housing 404, a rate of pumping of the solution is controlled such that the housing 404 remains filled with the solution and a desired contact or residing time is maintained between the solution and the membrane surfaces to facilitate the chemical reaction to take place to exchange or swap of ions between the membrane polymer and solution. Due to the reaction of the solution with the polymer, a salt is formed which is mixed inside the solution forming the mixture of the solution and the salt. This mixture exits the housing 404 through the outlet 432. In this manner, the pump 420 enables a continuous flow of the fresh solution inside the housing 404, while removing the mixture of solution and salt from the housing 404.

In the illustrated embodiment, the system 400 includes a single device 402, however, the system 400 may include a plurality of devices 402 either arranged in a series configuration or a parallel configuration. In the series configuration, the outlet 432 of one device 402 is connected to an inlet opening of another device 402, and so on. In this manner, the solution exiting one swap device 402 is fed to the adjacently arranged device 402 for exchanging halide ions with hydroxyl ions or carbonate ions.

In a parallel configuration, each of the devices 402 is connected to the pump 420 to receive the solution from the tank 422. The feed from the pump 422 is divided into a plurality of feeds with each feed being delivered to a separate device 402. Solution exiting the plurality of the devices 402 is directed to the tank 422.

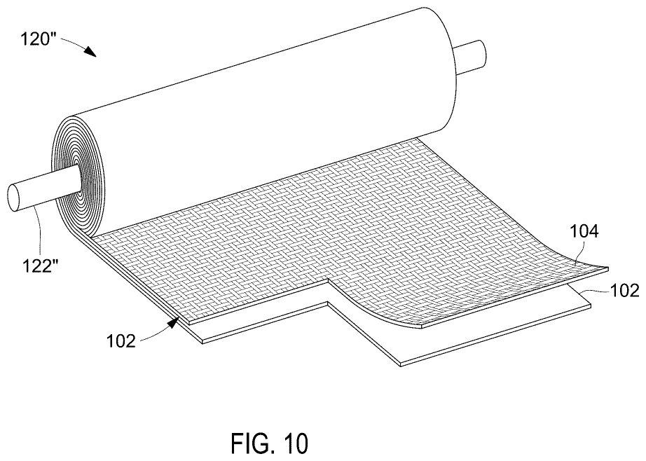

Referring to FIG. 10, an embodiment of a membrane structure 120″ is shown. The structure 120″ is similar to the assembly 120 except that instead of the tube 122, the membrane 100 and the spacer 104 are wound around a solid shaft 122″. In such a case, the solution enters a housing of A device through an inlet opening defined at a first end face of the housing and exit the housing through a second end face that may be arranged opposite to the first end face. In such a case, the solution moves in the axial direction through between the membrane layers 110.

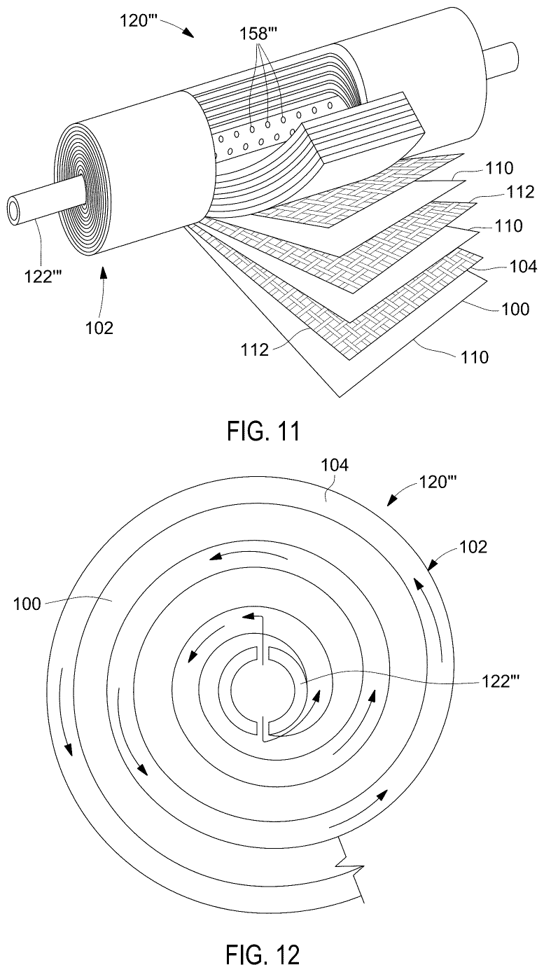

Referring to FIG. 11, another membrane structure embodiment 120″′ is shown. The assembly 120″′ is similar to the assembly 120 except that a tube 122″′ of the assembly 120″′ includes a plurality of outlet openings 158″′ extending in a radial direction of the tube 122″ and arranged underneath the spiral membrane structure 102. In such case, the solution upon exiting the tube 122″′ through the outlet openings 158″′ moves circumferentially around the tube 122″′ and between the membrane layers 110, as shown in FIG. 12 with the cross-sectional schematic of the membrane structure.

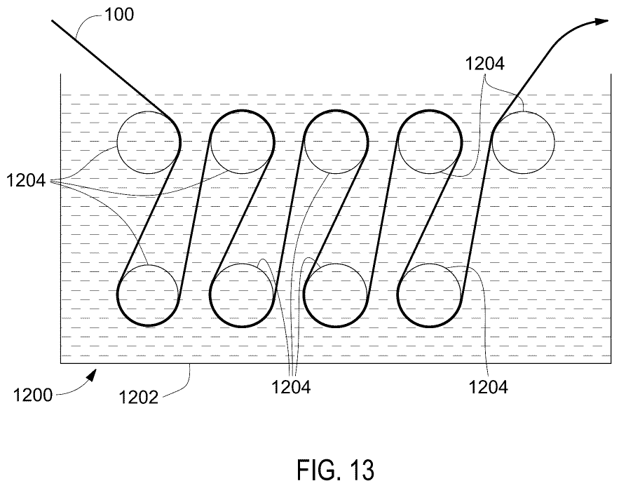

Referring to FIG. 13, an alternative system 1200 is shown. The system 1200 facilitates the ion exchange or swap between the membrane 100 and the solution without the need of the spacer 104, 104a, 104b. The system 1200 includes a housing 1202 and the solution stored inside the housing 1202 (as a static bath) or fed, continuously or intermittently, using a pump inside the housing 1200 (for a continuous or replenished mode). A spool of untreated membrane 100 is arranged outside the housing 1202 as a supply roll, and the treated membrane is wound around a suitable shaft which is rotatably mounted to another roller arranged outside the housing 1202. The system 1200 includes a plurality of rollers 1204 arrayed inside the housing 1202 and rotatably mounted to the housing 1202. The membrane is moved through the housing 1202, immersed inside the solution, along the plurality of rollers 1204, contacting each roller 1204. The residence time of the membrane 100 inside the solution may be controlled by controlling a speed of the movement of the membrane 100 through the housing 1202, providing a continuous “web process” suitable for treating long membrane rolls without interruption, maximizing throughput and uniformity of ion exchange, and eliminating the need for liners. In the embodiment, the plurality of rollers 1204 is arranged in substantially horizontal direction i.e., along a length of the housing 1202. However, the plurality of rollers 1204 may be arranged in a vertical direction, i.e., along a height of the housing 1202.

Examples 1-7 (Bromide-to-Hydroxide Ion Exchange of AEM). An anion exchange membrane in the form of a pentablock copolymer membrane from Notark Corporation in the bromide (Br⁻) form was used in the examples. The membrane was characterized by high mechanical strength, low swelling (<10% dimensional change in 1 M KOH at 80° C.), and alkaline stability exceeding 10,000 hours in 1 M KOH at 80° C., with a nominal thickness of 50-60 μm and an ion-exchange capacity (IEC) of approximately 1.6-1.8 meq/g, allowing for roll-to-roll handling and repeated immersion in hydroxide or carbonate solutions.

Membrane samples were cut into 2 cm×5 cm strips and immersed in aqueous potassium hydroxide (KOH) solutions under various test conditions to simulate operation of the device in batch mode, including variations in hydroxide concentration, temperature, residence time, and the use of a swelling-assist solvent such as ethanol. Except for Example 6, which was conducted at 60° C., all other examples were carried out at 25° C. Weight loss and in-plane ionic conductivity were measured to determine the degree of conversion from bromide to hydroxide form. Conductivity was determined according to the True Hydroxide Conductivity method (Dekel et al., Electrochemistry Communications, 2018).

TABLE 1

| | Electrolyte | Time | Activation | Conductivity | |
|---|---|---|---|---|---|
| Set | (M, solvent) | (hr) | (% by wt.) | (mS/cm, 60° C.) | Comments |
| 1 | 1M KOH (aq.) | 8 | 35 | 26 | Partial exchange onset |
| 2 | 1M KOH (aq.) | 12 | 50 | 32 | Progressive conversion |
| 3 | 1M KOH (aq.) | 24 | 60 | 36 | Approaching |
| | | | | | completion |
| 4 | 1M KOH (aq.) | 48 | 100 | 41 | Full Br— to OH— |
| | | | | | exchange |
| 5 | 2M KOH (aq.) | 24 | 98 | 42 | High-conc. accelerated |
| | | | | | swap |
| 6 | 1M KOH + | 1 | 95 | 40 | Rapid activation |
| | 25% EtOH | | | | |
| 7 | 2M KCl → 2M | 24 | 100 | 43 | Two-step uniform |
| | KOH (seq.) | | | | exchange |

The results show that bromide-to-hydroxide exchange proceeds steadily in aqueous KOH and can be accelerated by increasing hydroxide concentration, raising temperature, or adding a swelling-assist solvent such as ethanol. Under optimized conditions (1 M KOH+25% EtOH at 60° C.), near-complete exchange was achieved within about 30 minutes, with ionic conductivities of ≈40 mS/cm at 60° C., matching or exceeding manufacturer specifications for the hydroxide form.

Across all test conditions, residual halide content decreased by >90% relative to the starting bromide form, and membranes retained their mechanical integrity without visible deformation. Fully converted membranes showed conductivities of 35-45 mS/cm at 60° C. and <1% residual halide, consistent with the reported properties of the starting membrane.

Performance and Advantages: The treatment process applied to CEMs and PEMs provides measurable and controllable improvements in membrane performance. Exchanging from a multivalent metal form (e.g., Mg²⁺ or Ca²⁺) to a monovalent or proton form increases ionic conductivity by at least 20-200% (for example, from 5-20 mS/cm in the Mg²⁺ form to 10-60 mS/cm in the H⁺ or Na⁺ form at 25° C.). Converting the membrane to a lithium or sodium form can reduce water uptake by 10-40% and dimensional swelling by at least 5%, at least 10%, or 7-25% relative to the proton form while maintaining conductivity levels appropriate for alkaline or battery environments. The change in ionic form can also modify the tensile modulus by up to 20%, or 30%, or 40%, improving mechanical robustness without sacrificing transport efficiency. Because the disclosed system allows the same membrane to be reconditioned or reconverted in situ simply by changing the contacting solution, corrosion of electrodes and scaling from electrolyte replacement are minimized. Under comparable operating conditions, such in situ treatment can extend membrane service life by at least 25-50% relative to conventional fixed-ion-form operation.

The disclosed device and system can be applied to anion, cation, or proton exchange membranes by selecting an electrolyte solution containing the appropriate ions. The device functions both as an activation platform for newly manufactured membranes and as a reconditioning unit for membranes used in electrochemical cells, providing consistent control of ionic form, conductivity, and mechanical stability across diverse membrane chemistries and electrochemical applications.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “includes” and its grammatical variants are intended to be non-limiting, such that recitation of items in a list is not to the exclusion of other like items that can be substituted or added to the listed items.

As used herein, the term “comprising” means including elements or steps that are identified following that term, but any such elements or steps are not exhaustive, and an embodiment can include other elements or steps. Although the terms “comprising” and “including” have been used herein to describe various aspects, the terms “consisting essentially of” and “consisting of” can be used in place of “comprising” and “including” to provide for more specific aspects of the disclosure and are also disclosed.

Unless otherwise specified, all technical and scientific terms used herein have the same meanings as commonly understood by one of skill in the art to which the disclosed disclosure belongs. the recitation of a genus of elements, materials, or other components, from which an individual component or mixture of components can be selected, is intended to include all possible sub-generic combinations of the listed components and mixtures thereof.

The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims. To an extent not inconsistent herewith, all citations referred to herein are hereby incorporated by reference.

1. A device for treating an ion-conductive polymer membrane, comprising:
(a) a housing configured to contain a liquid treatment solution for ion exchange or quaternization of the membrane, the membrane is selected from anion exchange membranes, cation exchange membranes, and proton exchange membranes, the membrane having an ion-exchange capacity of 0.5 to 5.0 meq/g of dry polymer;
(b) at least one support element positioned in relation to the polymer membrane, the support element being configured for at least a surface of the membrane to be in contact with the liquid treatment solution containing a reactive or ionic species; and
(c) at least one inlet and outlet configured to allow circulation, filling, or replacement of the liquid treatment solution within the housing;
wherein:
the liquid treatment solution contains an ionic species suitable for ion exchange or a reactive species suitable for quaternization; and
the device is configured to perform ion exchange or quaternization by contacting the membrane with the liquid treatment solution.

2. The device of claim 1, wherein the support element comprises a roller about which the membrane is spooled.

3. The device of claim 1, wherein the support element is a spacer, the spacer comprises a structure selected from the group consisting of:
a) a mesh structure having a plurality of first strands arranged spaced apart in a first direction and a plurality of second strands arranged spaced apart in a perpendicular second direction;
b) belt-shaped tracks arranged along longitudinal edges of the membrane and including holes to permit flow of solution between membrane layers; and
c) a sheet or frame having a plurality of raised bumps or projections distributed across its surface to maintain separation between adjacent membrane layers.

4. The device of claim 1, wherein:
the membrane is an anion exchange membrane (AEM) having halide counterions selected from chloride, bromide, or iodide, and
the liquid treatment solution comprises ionic species selected from the group consisting of hydroxide, carbonate, bicarbonate ions, and mixtures thereof, at a concentration of 0.1 to 7 molar (M), the ionic species replacing the halide counterions of the membrane with hydroxide or carbonate ions during treatment.

5. The device of claim 1, wherein:
the membrane is a cation exchange membrane (CEM) containing anionic functional groups selected from sulfonate, carboxylate, or phosphonate groups having charge-balancing cations selected from hydrogen, sodium, potassium, or other metal cations, and
the liquid treatment solution comprises ionic species selected from the group consisting of lithium, sodium, potassium, magnesium, and calcium ions at a concentration of 0.01 to 7 molar (M), the ionic species exchanging with the charge-balancing cations of the membrane during treatment.

6. The device of claim 1, wherein:
the ion exchange membrane is a proton exchange membrane (PEM) comprising acid groups selected from sulfonic acid, phosphonic acid, or carboxylic acid groups, each acid group having a charge-balancing proton; and
the liquid treatment solution comprises ionic species selected from the group consisting of:
(i) protons provided by an acid selected from hydrochloric acid, sulfuric acid, nitric acid, or phosphoric acid at a concentration of 0.01 to 7 molar (M) to return the membrane to its proton form, or
(ii) metal cations provided by an aqueous solution of a metal salt selected from salts of lithium, sodium, potassium, magnesium, or calcium at a concentration of 0.01 to 7 molar (M) to replace the charge-balancing protons of the membrane with metal cations during treatment.

7. The device of claim 1, wherein:
the ion-conductive polymer membrane comprises a brominated or tosylated polymer having reactive sites formed by carbon-halogen bonds or carbon-tosyl bonds; and
the liquid treatment solution comprises reactive species selected from primary, secondary, tertiary, or cyclic amines,
the reactive species converting the carbon-halogen or carbon-tosyl bonds of the polymer into quaternary ammonium groups covalently attached to the polymer, thereby producing an anion exchange membrane having quaternary ammonium functional groups with halide or tosylate counterions after treatment.

8. The device of claim 7, wherein the liquid treatment solution is selected from the group consisting of trimethylamine, triethylamine, N,N-dimethylethylamine, N-methylpiperidine, N-methylmorpholine, 1,4-diazabicyclo[2.2.2]octane, imidazole, and N-methylimidazole, at a concentration of 0.1 to 5 M and a temperature of 10 to 80° C.

9. The device of claim 8, wherein the membrane produced by quaternization has quaternary ammonium functional groups with halide or tosylate counterions and an ion-exchange capacity of 0.5 to 4.0 meq g⁻¹ of dry polymer.

10. The device of claim 1, comprising two or more housings connected in series or parallel flow configuration to permit sequential or simultaneous ion-exchange or quaternization operations.

11. The device of claim 1, wherein the housing is configured for batch treatment in which the membrane is immersed in the liquid treatment solution for a residence time of 10 minutes to 48 hours at a temperature of 20 to 60° C.

12. The device of claim 1, wherein the housing is configured for continuous operation in which the liquid treatment solution is circulated by a pump to provide an effective residence time of 0.1 to 6 hours at a flow rate of 0.05 to 5 liters per minute.

13. The device of claim 1, configured for sequential treatment in which a first liquid treatment solution performs quaternization of a polymer membrane and a second liquid treatment solution performs ion exchange of the quaternized polymer membrane.

14. The device of claim 1, wherein the housing defines a spiral-wound configuration comprising alternating membrane and spacer layers forming flow channels for uniform solution contact.

15. The device of claim 1, wherein the ion-exchange treatment achieves an ion-exchange efficiency of greater than 80%.

16. The device of claim 1, further comprising:
(a) a tank or reservoir configured to contain the liquid treatment solution or to collect a discharge from the device; and
(b) a pump or flow-control unit fluidly connected to the device and the tank or reservoir to circulate or transfer the liquid treatment solution through the device for ion exchange or quaternization of the ion-conductive polymer membrane contained in the device.

17. The device of claim 16, wherein the tank or reservoir comprises a first tank for supplying the liquid treatment solution to the device and a second tank for collecting discharge from the device.

18. The device of claim 3, wherein the spacer is compressible and elastically deforms by 5 to 70 percent of its original thickness when the membrane swells in the liquid treatment solution.

19. The ion-conductive polymer membrane of claim 18, wherein at least one surface of the membrane bears a repeating indentation, ridge, or pattern corresponding to a contact area of a spacer or support element used during treatment.

20. A method for treating an ion-conductive polymer membrane, the method comprising:
(a) providing a ion-conductive polymer membrane and a support element arranged in relation to the membrane, the support element being configured for at least a surface of the membrane to be in contact with a liquid treatment solution, the membrane is selected from anion exchange membranes, cation exchange membranes, and proton exchange membranes, the membrane having an ion-exchange capacity of 0.5 to 5.0 meq/g of dry polymer and the liquid treatment solution contains an ionic species suitable for ion exchange or a reactive species suitable for quaternization;
b) positioning the membrane and the support element inside a housing;
c) contacting the membrane with the liquid treatment solution for a predetermined time to facilitate treatment of the membrane by ion exchange or quaternization.
